(19) United States
(12) Patent Application Publication
(10) Pub. No.: US 2013/0125486 A1
(43) Pub. Date: May 23, 2013

(54) ENERGY EFFICIENT ACCESS FLOOR PANELS AND SYSTEMS

(71) Applicants: Daniel J. CURTIN, Alexandria, VA (US); William W. REYNOLDS, Pasadena, MD (US); Daniel B. KENNEDY, Lovettsville, VA (US); Peter R. STRAPP, Silver Spring, MD (US); Daniel J. CATALFU, Red Lion, PA (US); Steven A. ENGLAR, York, PA (US); John K. HAN, Parkton, MD (US)

(72) Inventors: Daniel J. CURTIN, Alexandria, VA (US); William W. REYNOLDS, Pasadena, MD (US); Daniel B. KENNEDY, Lovettsville, VA (US); Peter R. STRAPP, Silver Spring, MD (US); Daniel J. CATALFU, Red Lion, PA (US); Steven A. ENGLAR, York, PA (US); John K. HAN, Parkton, MD (US)

(73) Assignee: KINGSPAN HOLDINGS (IRL) LIMITED, Co Cavan (IE)

(21) Appl. No.: 13/304,047

(22) Filed: Nov. 23, 2011

(51) Int. Cl. E04B 5/43; E04B 1/70; B23P 17/04; E04F 17/04

(52) U.S. Cl. 52/302.1; 52/474; 29/428

(57) ABSTRACT

An access floor panel is provided that includes a support frame that supports a phase change material. The phase change material changes phases at a certain temperature. The support frame may form a shell having a cavity. The cavity may be filled with the phase change material or with a mixture of the phase change material and a fill material. The access floor panels can be every panel in an access floor system or selected panels in the system.

### BACKGROUND

1. Field of the Invention

This invention relates to access floor panels and systems. In particular, this invention relates to access floor panels and systems that save energy by absorbing thermal (heat) energy during high thermal load (high temperature) periods, thus reducing the cooling requirements for facilities including the panels and systems during those high thermal load periods.

2. Background of the Invention

Sunlight entering office spaces, other places of business, and public buildings through windows and other fully or partially transparent building components often causes excess heat in those facilities. That sunlight usually increases the heat load in those facilities as the work day progresses, often taxing air conditioning systems during peak work hours, which are also peak energy usage hours.

In addition, a typical office space or data center includes multiple pieces of electronic equipment as well as associated peripheral equipment and cables that generate a relatively high amount of heat. The use of that electronic equipment generally increases during a work day, thus increasing the heat generated in an office space or a data center as a work day progresses.

Providing adequate cooling of office spaces, data centers, other places of business, and public buildings is of paramount importance to maintain a comfortable working environment, to prevent damage to equipment, and to create a welcome environment for visitors. Those facilities must be maintained at appropriate temperatures, including during high thermal load periods.

It is desirable that those facilities be cooled as efficiently as possible. For example, the energy costs to cool an office space or a data center may approach a large percentage of the energy costs to operate the office space or the data center. One way to render the cooling systems for those facilities more efficient is by reducing the cooling demands during high thermal load periods.

Many data centers and some office spaces, other places of business and public buildings have a raised floor system, often called an access floor system. An access floor system is usually comprised of a continuous array of floor panels, arranged edge-to-edge, and supported above the sub-floor by support structure. The array of access floor panels usually extends wall-to-wall in the office space or data center.

### SUMMARY OF THE INVENTION

The access floor panels and systems of this invention contribute to the efficient cooling of office spaces and data centers by absorbing thermal energy during high thermal load periods, thus reducing cooling demands during those high thermal load periods.

In some embodiments of this invention, the access floor panels include a support frame and a phase change material supported by the support frame. The phase change material changes phases at a certain temperature.

In other embodiments of this invention, the support frame may form a shell having a cavity, with the cavity being filled with the phase change material or a fill mixture that includes the phase change material. The fill mixture may include a mixture of the phase change material and a fill material. The phase change material may be dispersed within the fill material.

In yet other embodiments of this invention, the cavity formed by the shell may be partially filled with the phase change material and partially filled with the fill material.

In further embodiments of this invention, the shell formed by the support frame may have a plurality of cavities, and some of the cavities may be filled with the phase change material and other of the cavities may be filled with the fill material.

In yet other embodiments, the phase change material may be provided in a laminate that is attached to the top of the support frame. The phase change material may be embedded within the laminate.

In further embodiments, the phase change material may be provided in an enclosure or casing that forms the underside of the support frame.

According to some access floor system embodiments of this invention, all of the system's access floor panels may include phase change material. In other access floor system embodiments of this invention, only selected panels include phase change material.

In yet other access floor system embodiments of this invention, the systems include a plurality of access floor panels that do not include phase change material and one or more thermal dampers intermixed with those access floor panels that include phase change material. The one or more thermal dampers include a box-shaped shell that contains the phase change material. The top surfaces of the dampers may be substantially aligned with the top surfaces of the access floor panels.

### BRIEF DESCRIPTION OF THE DRAWINGS

FIG. 1 is a partial view of an access floor system embodiment of this invention.

FIG. 2 is a cross-sectional view of one access floor panel embodiment of this invention.

FIG. 3 is a cross-sectional view of another access floor panel embodiment of this invention.

FIG. 4 is a cross-sectional view of yet another access floor panel embodiment of this invention.

FIG. 5 is a partial view of another access floor system embodiment of this invention.

FIGS. 6-8 are embodiments of a thermal damper according to this invention.

FIG. 9 is a schematic diagram illustrating one embodiment of providing an access floor panel with a fill mixture of phase change material and a fill material.

### DETAILED DESCRIPTION

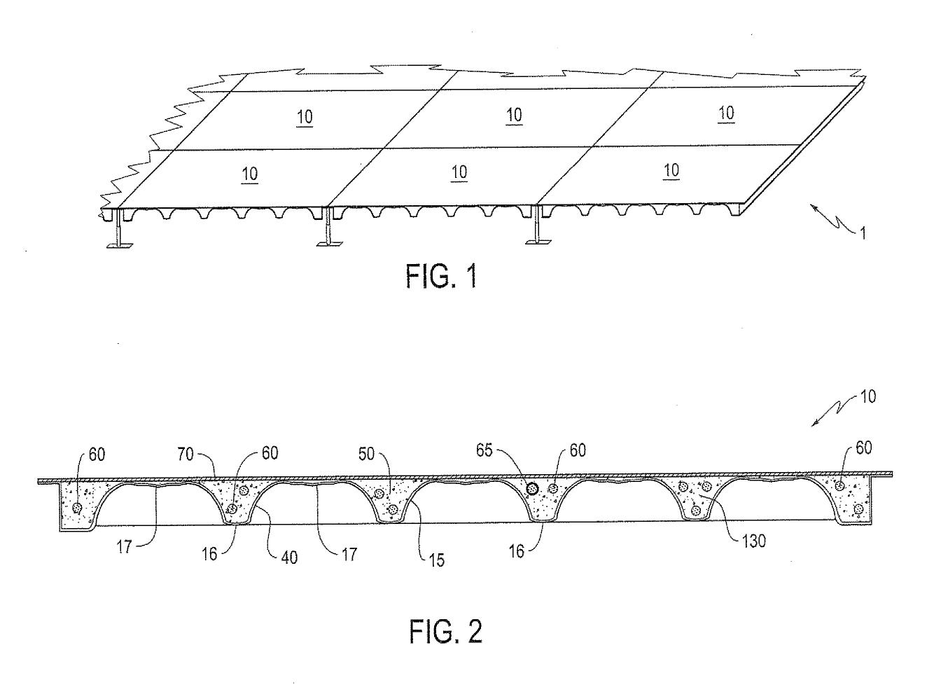

FIG. 1 is a partial view of access floor system 1, which, as stated, is an access floor system embodiment of this invention. Access floor system 1 includes multiple access floor panels 10 arranged edge-to-edge in an array that usually extends wall-to-wall in a room.

FIG. 2 illustrates access floor panel 10, which, as stated, is an access panel embodiment of this invention. Access floor panel 10 includes shell 15 filled with fill mixture 50. More specifically, shell 15 includes lower shell 40 and top plate 70, which define a cavity or multiple cavities that contain fill mixture 50. In the embodiment illustrated in FIG. 2, fill mixture 50 substantially fills the cavity or cavities formed by lower shell 40 and upper plate 70.

Lower shell 40 and top plate 70 can be made of any material that is capable of providing the structural rigidity required for a given application. Preferably at least part of lower shell 40 and top plate 70 is made of a metal. Lower shell 40 and/or top plate 70 can be made entirely of metal.

Lower shell 40 has a plurality of longitudinally and laterally spaced peak portions 16 and valley portions 17 for structural rigidity. The number of peaks and valleys may vary depending on the size of the access floor panel 10 and other considerations. Top plate 70 is usually welded to lower shell 15 at one or more of the valley portions 17, i.e., at the areas where lower shell 15 is adjacent top plate 70. In addition to providing structural integrity to the panel, those welds provide for additional heat transfer through panel 10.

In the embodiment illustrated by FIG. 2, fill mixture 50 includes phase change material 60 dispersed within fill material 130. That is, fill mixture 50 is comprised of a mixture of phase change material 60 and fill material 130. Phase change material 60 can be homogeneously or heterogeneously mixed with fill material 130.

In other embodiments, the cavity or cavities of shell 15 can be filled with only phase change material 60. In yet other embodiments, part or parts of the cavity of shell 15 (if shell 15 has one cavity) can be filled with phase change material 60 while the other part or parts of the cavity are empty and/or are filled with fill material 130. If shell 15 has multiple cavities, one or more of the cavities can be filled with phase change material 60, while the remaining cavities are empty and/or filled with fill material 130.

When dispersed within fill material 130, phase change material 60 may be provided in either a micro-encapsulated form, as illustrated in FIG. 2, or a non-encapsulated form. When phase change material 60 is in the micro-encapsulated form, particles or clumps of particles of phase change material 60 are encased in casings 65 that can be formed of PVC or any other suitable plastic or non-plastic material.

Fill material 130 can be, for example, any one of, or a combination of, concrete, cement, calcium sulfate and wood particles. Preferably, fill material 130 is cement.

The percentages of fill material 130 and phase change material 60 in fill mixture 50 may be anywhere from 1% phase change material 60 and 99% fill material 130 to 99% phase change material 60 and 1% fill material 130, depending, at least in part, on the thermal load that is desired to be absorbed. Moreover, the ratios can be by weight or by volume. One preferred mixture is approximately 12.5% phase change material 60 and approximately 87.5% fill material 130 (by weight). As stated, in some embodiments, phase change material 60 may be the only material in the cavity or cavities of shell 15, to the exclusion of fill material 130.

Phase change material 60 can be comprised of any acceptable material that changes from a solid to a liquid and vice versa at the desired temperature. An example is Microtek Laboratories, Inc.'s microencapsulated phase change material sold under the designation MPCM 24-D. In one embodiment, phase change material 60 changes phase at approximately 75° F. That is, the phase change material transitions (i.e., melts) from a solid to a liquid at approximately 75° F.

In this embodiment, when phase change material 60 changes from a solid to a liquid, each panel 10 can absorb upwards of 220 BTU thermal energy, which would otherwise be reflected back into the facility and/or transferred into the airstream. Thus, by providing phase change material 60 in access floor panels 10 of access floor panel system 1, temperature fluctuations and cooling demands can be reduced during high thermal load periods, because phase change material 60 melts and absorbs thermal energy during those high thermal load periods. The absorbed thermal energy can then be “held” within access floor panels 10 until access floor panels 10 are exposed to cooler temperatures during the off peak hours, such as during the night, at which time phase change material 60 resolidifies and releases thermal energy. In that regard, access floor panels 10 function as a thermal damper in the office space or data center in which they are installed.

Panels 10 can be every panel in access floor system 1, as illustrated in FIG. 1, or select panels in access floor panel system 1 can be panels 10 and the other panels in the system can be access floor panels of other types. For example, access floor panels 10 may be selectively provided in locations of access floor panel system 1 that are adjacent to or otherwise subjected to high thermal loads, such as direct exposure to sun light or a high concentration of electronics equipment.

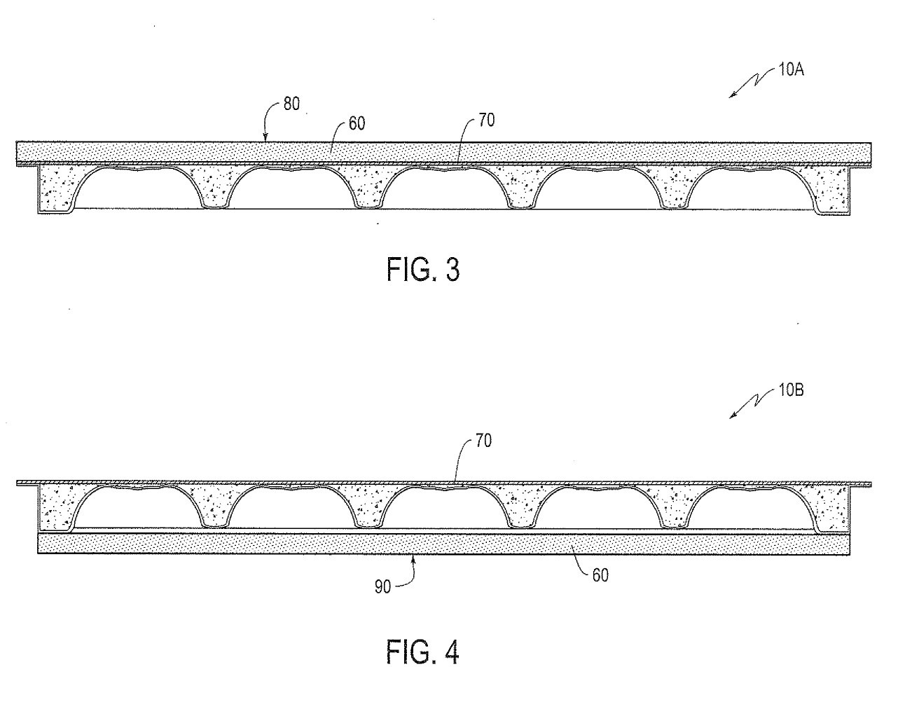

FIG. 3 illustrates another access floor panel embodiment of this invention, access floor panel 10A. In access floor panel 10A, instead of phase change material 60 being in a cavity formed by a shell, phase change material 60 is embedded in a laminate material 80 that is adhered or otherwise affixed to top plate of the access floor panel 10A. Preferably, laminate material 80 is made of Formica® Melaminetop or Paper Product Core.

FIG. 4 illustrates another access floor panel embodiment of this invention, access floor panel 10B. In access floor panel 1013, phase change material 60 is provided in an enclosure 90 that is the bottom portion of access floor panel 10B. Enclosure 90 can be filled with 100% phase change material 60 or with any of the fill mixtures 50 described above. Enclosure 90 can be formed of metal or any other suitable material.

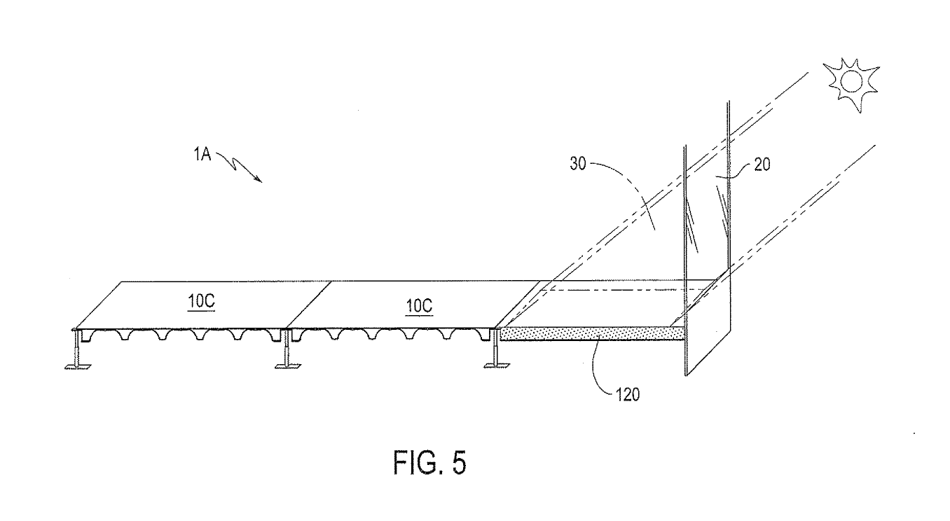

FIG. 5 illustrates another access floor system embodiment of this invention, access floor system 1A. Access floor system 1A includes one or more thermal dampers 120 that are interspersed among access floor panels 10C. That is, access floor system 1A includes access floor panels 10C (with no phase change material 50) and one or more thermal dampers 120. The embodiment illustrated in FIG. 5 has thermal damper 120 next to a window 20 so as to be able to dampen solar heat from sunlight 30. However, thermal damper 120 can be provided in other portions of access floor panel system 1A, as desired.

The top surface of the one or more thermal dampers 120 can be at the same height or below the height of the top surfaces of access floor panels 10C in access floor system 1A.

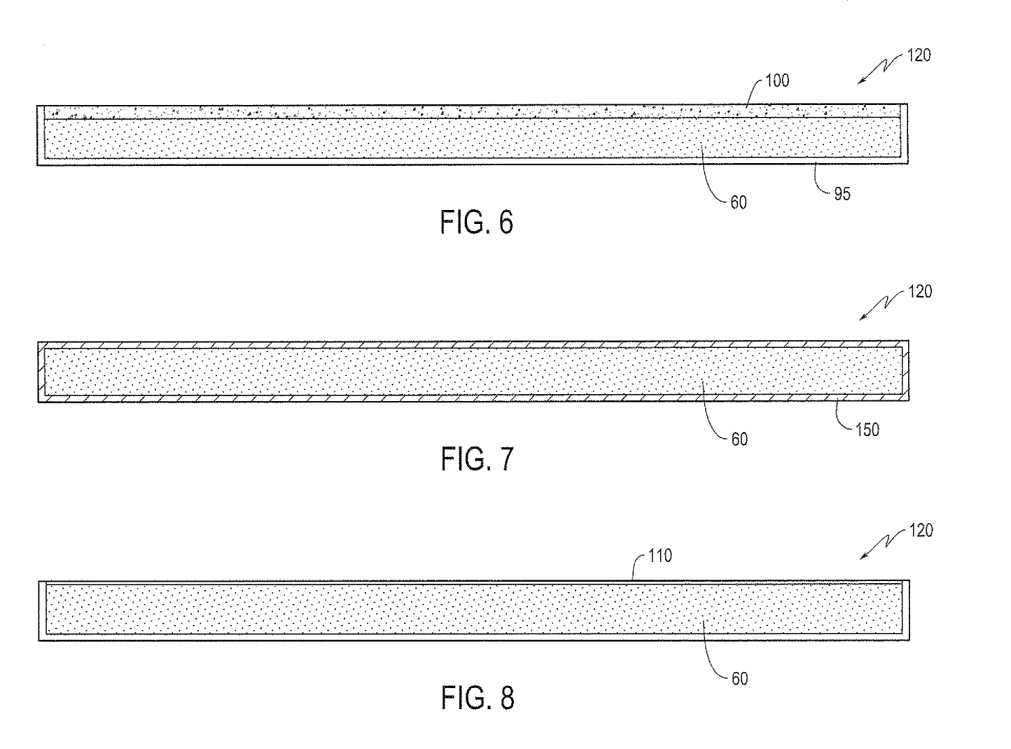

FIGS. 6-8 are cross-sectional views of different embodiments of thermal damper 120. In the embodiment illustrated in FIG. 6, a concrete or other structural bearing material 100 is provided on top of lower pan 95, and phase change material 60 or fill mixture 50 is provided in a cavity defined by bearing material 100 and lower pan 95. FIG. 7 illustrates an embodiment in which metal pan 150 completely encases phase change material 60. FIG. 8 illustrates an embodiment similar to that illustrated in FIG. 6, except that laminate material 110 is provided as the top surface instead of the bearing material 100.

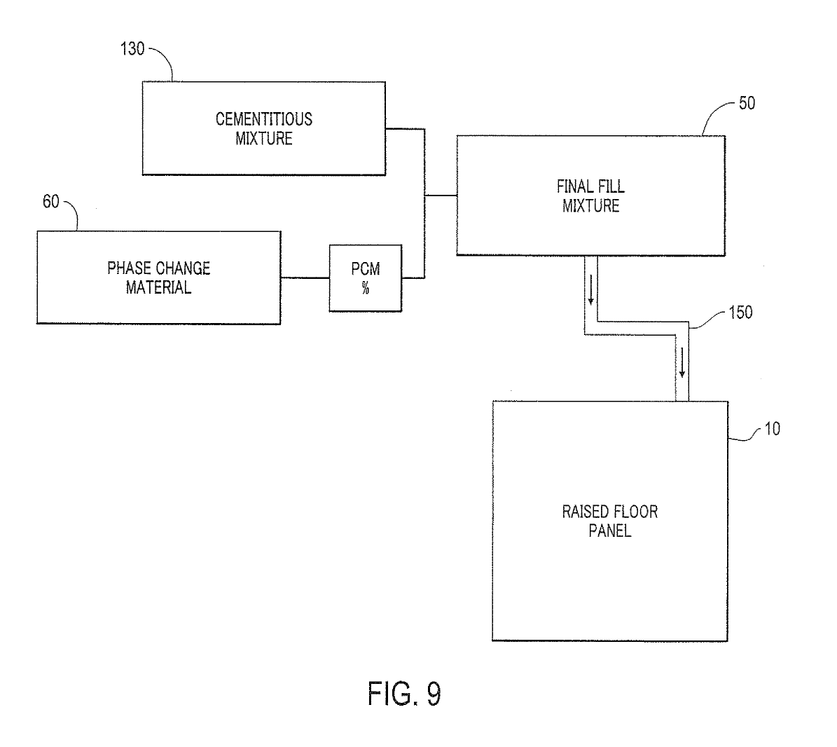

FIG. 9 is a schematic diagram illustrating one embodiment of the process of mixing phase change material 60 with fill material 130 to produce fill mixture 50, which, in this embodiment, is then transferred to the access floor panel 10 via a fill line 150.

Use of access floor panels 10, 10A and/or 10B and/or thermal dampers 120 in access floor panel systems 1 and/or 1A in an office space or data center should reduce temperature fluctuations and save energy in the office space or data center. Panels 10, 10A and 10B and thermal dampers 120 add thermal building mass to an office space or data center, and store thermal energy during high thermal load periods. That should result in energy savings during high thermal load periods due to lower HVAC demands during those periods. Those thermal loads during high load periods are essentially shifted to off peak hours, such as during nights. Shifting the thermal load to off peak hours may also result in an energy cost savings because unit energy costs may be lower in off peak hours.

What has been described and illustrated herein are preferred embodiments of the invention along with some variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. An access floor panel comprising;
a support frame; and
a phase change material supported by the support frame, wherein the phase change material changes from one phase to another phase at a certain temperature.

2. The access floor panel according to claim 1, wherein
the support frame forms a shell having a cavity; and
the cavity is filled with a fill mixture that includes the phase change material.

3. The access floor panel according to claim 2, wherein
the support frame extends the width and length of the panel.

4. The access floor panel according to claim 2, wherein
the fill mixture includes a mixture of the phase change material and a fill material, the phase change material being dispersed in the fill material.

5. The access floor panel according to claim 4, wherein
the phase change material is micro-encapsulated in the fill material.

6. The access floor panel according to claim 5, wherein
the casing of the micro-encapsulated phase change material is formed of plastic.

7. The access floor panel according to claim 4, wherein
the fill material comprises at least one of concrete, cement, calcium sulfate and wood particles.

8. The access floor panel according to claim 7, wherein
the fill mixture comprises about 87.5% of fill material and 12.5% of the phase change material.

9. The access floor panel according to claim 4, wherein
the phase change material is a petroleum based material.

10. The access floor panel according to claim 1, wherein
the phase change material changes from a solid to a liquid at a temperature of approximately 75° F.

11. The access floor panel according to claim 1, wherein
the support frame forms a shell having a cavity; and
the cavity is partially filled with the phase change material and partially filled with a fill material.

12. The access floor panel according to claim 1, wherein
the support frame forms a shell having a plurality of cavities; and
some of the plurality of cavities are filled with the phase change material and other of the plurality of cavities are filled with a fill material.

13. The access floor panel according to claim 1, wherein
the phase change material is provided in a laminate that is attached to the top of the support frame.

14. The access floor panel according to claim 1, wherein
the phase change material is provided within an enclosure that is attached to the underside of the support frame.

15. An access floor system comprising:
an array of access floor panels arranged edge-to-edge, wherein at least one of the array of access floor panels comprise the access floor panel according to claim 1.

16. An access floor system comprising:
an array of access floor panels arranged edge-to-edge; and
a thermal damper that includes a phase change material, wherein the thermal damper is placed among the array of access floor panels, edge-to-edge with one or more of the panels.

17. The access floor system according to claim 16, wherein
the damper includes a box-shaped shell forming a cavity; and
the phase change material is located within the cavity.

18. The access floor system according to claim 16, wherein
the damper includes a box-like shell forming a cavity; and
the cavity is filled with a mixture including the phase change material and a fill material.

19. The access floor system according to claim 17, wherein
the top surface of the damper is substantially aligned with the top surface of the array of access floor panels.

20. The method of making an access floor panel that includes a phase change material including:
combining the phase change material and a fill material to form a fill mixture; and
filling a shell of the access floor panel with the fill mixture.
